(19) United States
(12) Patent Application Publication
(10) Pub. No.: US 2008/0132259 A1
(43) Pub. Date: Jun. 5, 2008

(54) SYSTEM AND METHOD OF PROVIDING ACCESS TO INSTANT MESSAGING SERVICES VIA A WIRELESS NETWORK

(76) Inventor: Eric Vin, Sceaux (FR)

Correspondence Address: PERKINS COIE LLP, P.O. BOX 2168, MENLO PARK, CA, 94026, US

(21) Appl. No.: 11/951,250

(22) Filed: Dec. 5, 2007

Related U.S. Application Data
(60) Provisional application No. 60/873,171, filed on Dec. 5, 2006.

(51) Int. Cl. H04Q 7/20

(52) U.S. Cl. 455/466

(57) ABSTRACT

Systems and methods for providing access to instant messaging services are described in this application. In one aspect, embodiments of the present disclosure include a method, which may be implemented on a system, of receiving a request to access an instant messaging service from a mobile device through a first network protocol, the instant messaging service to be accessed via an Internet protocol. One embodiment can include, establishing a connection between the mobile device and a server of the instant messaging service via the Internet protocol through a gateway, and/or routing the message to the gateway to be forwarded to the server of the instant messaging service via the Internet protocol, the gateway to convert the message initiated from the mobile device from the first network protocol to the Internet protocol.

### CLAIM OF PRIORITY

This application claims priority to U.S. Patent Application No. 60/873,171 entitled “Providing Instant Messaging Services In Wireless Telecommunication Networks”, which was filed on Dec. 5, 2006, the contents of which are expressly incorporated by reference herein.

### TECHNICAL FIELD

The present disclosure relates generally to communications services, in particular, to applications of wireless telecommunications services.

### BACKGROUND

The utility of a communications network typically increases as more users join the network. Therefore, IM services providers prefer to streamline the process for users to join their network. In order to join an IM network, a user typically performs a number of tasks. For example, the potential IM user can purchase a compatible networked device such as a modern mobile phone, download and install a dedicated software application onto a networked personal computer, download and install a dedicated software application onto a mobile phone with an operating system (e.g., Windows, Symbian), download and install Java onto the mobile phone with a Java virtual machine, configure passwords, addresses and other technical settings, subscribe to a service contract, provide billing information, and/or pay for usage, etc.

Although the convoluted steps associated with joining in an IM network may potentially frustrate users, Internet-based IM services have gained traction due to ease of access to the software and installation procedure on a personal computing device. The Short Message Service (SMS) (e.g., text messaging) allows mobile handset users to send and receive messages. The deployment of SMS has generally been successful due to its development in the early stage of the mobile telephony industry and automatic availability to mobile subscribers.

Unfortunately, neither Instant Messaging and Presence Service (IMPS) nor similar TCP/IP-based systems can typically be offered to GSM service subscribers. Furthermore, the difficulties with which to develop reliable and user-friendly IM software applications is exacerbated with the wide range of devices on the market having vastly different capabilities, screen sizes and operating systems.

### SUMMARY OF THE DESCRIPTION

System and method of providing access to instant messaging services via a wireless network are described here. Some embodiments of the present disclosure are summarized in this section.

In one aspect, embodiments of the present disclosure include a method, which may be implemented on a system, of receiving a request to access an instant messaging service from a mobile device through a first network protocol. The instant messaging service can be accessed via an Internet protocol. The embodiment further includes establishing a connection between the mobile device and a server of the instant messaging service via the Internet protocol through a gateway. Further, the message to be forwarded to the server of the instant messaging service via the Internet protocol can be routed to the gateway. The gateway can convert the message initiated from the mobile device from the first network protocol to the Internet protocol.

In one embodiment, the message is one or more of an SMS message and a USSD message. The request to access the instant messaging service from the mobile device can be identified based on a destination address identifier of the SMS message initiated from the mobile device. The request to access the instant messaging service can be identified from the mobile device based on a service code of the USSD message initiated from the mobile device and/or identifying the request to access the instant message from the mobile device based on contextual data of the message initiated from the mobile device.

The first network protocol can be the Short Message Peer-to-peer Protocol (SMPP) or the Unstructured Supplementary Service Data (USSD) protocol. The Internet protocol can be TCP/IP. The Internet protocol may also be the Extensible Messaging and Presence Protocol (XMPP). The gateway can be the Unstructured Supplementary Service Data (USSD) gateway, the Short Message Service (SMS) gateway, and/or the Instant messaging (IM) gateway. In one embodiment, the mobile device-initiated message includes one or more of, availability of a user of the mobile device, login information, an invitation, and a text message.

One embodiment further includes presenting a user interface on the mobile device for accessing one or more functions available to the instant messaging service. The user interface can include a menu to access the one or more functions. For example, the functions can include, configuration of logon information, update of presence information, display of presence information of other users of the instant messaging service, invitation of the other users, and/or buttons for sending/accessing messages. One embodiment includes establishing a second connection between the mobile device and a server of a second instant messaging service and/or a third connection between the mobile device and a server of a third instant messaging service. In one embodiment, a plurality of connections are simultaneously maintained between the mobile device and servers of a plurality of instant messaging services

In one aspect, embodiments of the present disclosure includes a method, which may be implemented on a system, of receiving a request to send a message initiated from a server of the instant messaging service to the mobile device. The embodiment further includes establishing a connection between the mobile device and a server of the instant messaging service through the gateway via the Internet protocol, and routing the message to the gateway to be forwarded to the mobile device via the first protocol, the gateway to convert the message initiated from the instant messaging service from the Internet protocol to the first network protocol.

The message initiated from the server of the instant messaging service can include a text message, a notification, an invitation, and/or a presence status update. In one embodiment, the message is stored on the gateway to be transmitted to the mobile device when the mobile device is engaged in a USSD communication session, via the USSD protocol. One embodiment includes determining that the mobile device is engaged in a USSD communication session and transmitting the message to the mobile device via the USSD protocol. In addition, the message can be transmitted to the mobile device via the Short Message Peer-to-peer Protocol (SMPP).

The present disclosure includes methods and systems which perform these methods, including processing systems which perform these methods, and computer readable media which when executed on processing systems cause the systems to perform these methods. Other features of the present disclosure will be apparent from the accompanying drawings and from the detailed description which follows.

### BRIEF DESCRIPTION OF THE DRAWINGS

FIG. 1 illustrates a block diagram of a plurality of mobile devices coupled to an instant messaging (IM) network to access IM services via a wireless (e.g., mobile wireless) network, according to one embodiment.

FIG. 2 depicts a block diagram illustrating a plurality of network elements in a routing system to couple a wireless network to an IM network, according to one embodiment.

FIG. 3 depicts a block diagram illustrating a plurality of network elements in a routing system to couple a wireless network to an IM network, according to one embodiment.

FIG. 4 depicts a block diagram illustrating components of a system for coupling a wireless network to an IM network, according to one embodiment.

FIG. 5 illustrates example screenshots of user interfaces of a mobile device for accessing IM services and managing IM subscriptions, according to one embodiment.

FIG. 6 depicts a flow diagram illustrating a process of identifying a request to access an IM service via a mobile device, according to one embodiment.

FIG. 7 depicts a flow diagram illustrating a process of sending a mobile device-initiated message to an IM server via a wireless network, according to one embodiment.

FIG. 8 depicts a flow diagram illustrating a process of sending an IM-initiated message to a mobile device, according to one embodiment.

FIG. 9 depicts an interaction diagram between a mobile device, gateway, and IM server for configuring the IM service via Unstructured Supplementary Service Data (USSD), according to one embodiment.

FIG. 10 depicts an interaction diagram illustrating the communications between a mobile device, gateway, and IM server for updating presence information via USSD messages/commands, according to one embodiment.

FIG. 11 depicts an interaction diagram illustrating the communications between a mobile device, gateway, and IM server for generating invitations via USSD messages/commands, according to one embodiment.

FIG. 12 depicts an interaction diagram illustrating the communications between a mobile device, gateway, and IM server for receiving invitations via USSD messages/commands, according to one embodiment.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the invention. Unless otherwise defined, all technical and scientific terms used herein have the same meaning as commonly understood by one of ordinary skill in the art to which this disclosure pertains. In the case of conflict, the present document, including definitions will control.

Embodiments of the present disclosure include systems and methods, for providing access to instant messaging (IM) services via a wireless network. Embodiments of the present disclosure further relate to utilizing Short Message Service (SMS) messages and/or Unstructured Supplementary Service Data (USSD) messages/commands to access web-based IM services. In particular, a mobile device connected to wireless network (e.g., GSM, 2G, 3G, etc.) can exchange USSD and/or SMS messages/commands via a gateway to communicate with IM services.

For example, commands and messages (e.g., SMS and/or USSD) initiated from a mobile device can be used to access various services provided by an IM server. A mobile device user can communicate and exchange data (e.g., text) in real-time or near real-time with an IM service subscriber currently online. The mobile device user can configure the settings for IM service by sending messages and/or commands from the mobile device. In some embodiments, the operator can maintain a list of friends from the mobile device, which in some instances, include the presence information of operator's friends. The operator can update his/her presence information in a similar fashion.

Instant messaging services described herein include, but are not limited to communication having textual data transmitted between various participants of a communication session (e.g., chat session, group chat session) over a network (e.g., Internet). In most instances, instance messaging services can relay messages in real-time or in near real-time between at least two participants in a chat session.

Some functions that can be implemented in accordance with the spirit of the disclosure include those that explicitly or implicitly relate to establishing a connection with IM services based on the TCI/IP protocol with mobile wireless systems. Yet other applications are contemplated beyond use of the disclosure in association with any other IM services provided via other known and/or convenient protocols. Yet further applications are contemplated such as providing access to IM functions by way of example but not limitation, account management, presence update, contacts management (e.g., buddies, friends), invitations, text messaging, etc.

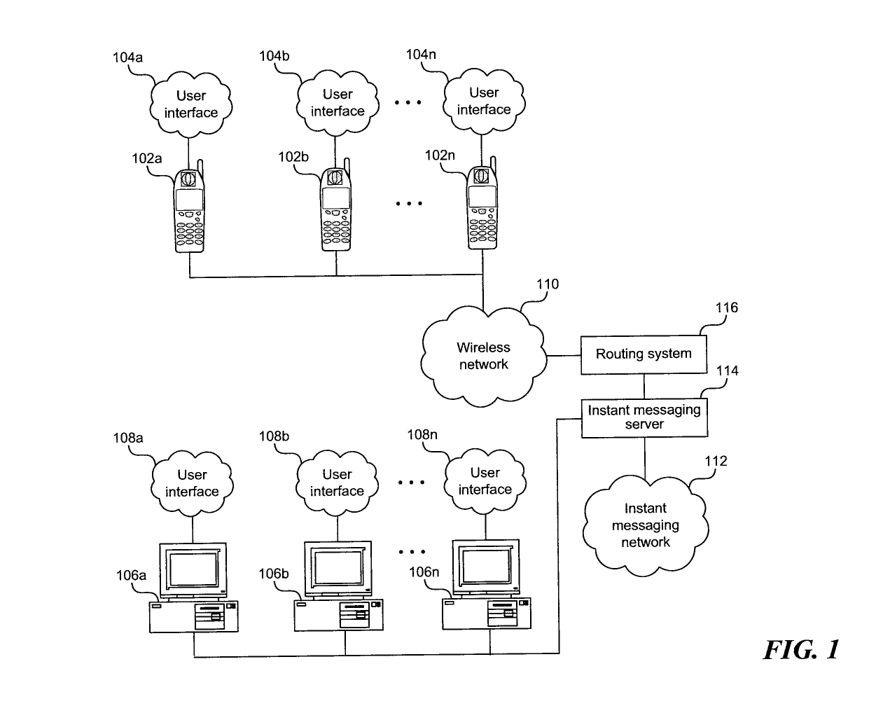

FIG. 1 illustrates a block diagram of a plurality of mobile devices 102A-N coupled to an instant messaging (IM) network 112 to access IM services via a wireless (e.g., mobile wireless) network 110, according to one embodiment.

The plurality of mobile devices 102A-N can be any system and/or device, and/or any combination of devices/systems that is able to establish a connection with a wireless network (e.g., wireless network 110). The mobile devices 102A-N typically include a screen or other output display functionalities to present data exchanged between the devices to a user, such as to display user interfaces 104A-N. For example, the mobile devices 102A-N can be, but are not limited to, a mobile computing device, a mobile phone, a cellular phone, a smart phone, a PDA, a Blackberry device, a Treo, and/or an iPhone, etc.

In one embodiment, the mobile devices 102A-N and client devices 106A-N are coupled via a wireless network 110, a routing system 116, an IM server 114, and the IM network 112. The plurality of client devices 106A-N can be any system and/or device, and/or any combination of devices/systems that is able to establish a wired or wireless connection with another device, servers and/or other systems. The client devices 106A-N may also include a screen or other output display functionalities to present data exchanged between the devices to a user, such as, to display user interfaces 108A-N. For example, the client devices and content providers can be, but are not limited to, a processing unit, a server desktop, a desktop computer, a computer cluster, a mobile computing device such as a notebook, a laptop computer, a handheld computer, a mobile phone, a smart phone, a PDA, a Blackberry device, a Treo, and/or an iPhone, etc.

The wireless network (e.g., mobile wireless network) 110 can be any network able to establish connections with mobile devices 102A-N, such as mobile phones. The wireless network 110 can be, but is not limited to Global System for Mobile Communications (GSM), Code Division Multiple Access (CDMA), Evolution-Data Optimized (EV-DO), Enhanced Data Rates for GSM Evolution (EDGE), 3GSM, Fixed Wireless Data, 2G, 2.5G, 3G networks, enhanced data rates for GSM evolution (EDGE), General packet radio service (GPRS), enhanced GPRS Digital Enhanced Cordless Telecommunications (DECT), Digital AMPS (IS-136/TDMA), and Integrated Digital Enhanced Network (iDEN).

GSM networks typically provide wireless service providers with the ability to offer roaming services to subscribers when they travel outside of the region (e.g., country) where subscription is based. Communication services provided by the wireless network 110 may further support messaging protocols such as, but is not limited to, Multimedia Messaging Service (MMS), SMS, USSD, IRC, or any other wireless data networks or messaging protocols.

In particular, GSM networks typically offer Short message service (SMS), or text messaging services to subscribers, thus allowing, for example, mobile device users (e.g., users of mobile devices 102A-N) to send text messages to one another. SMS is typically supported by mobile standards such as ANSI CDMA networks, 3G, AMPS, satellite, and/or landline networks. The Short Message Service-Point to Point (SMS-PP) is defined in the GSM recommendation 3GPP TS 23.040/3GPP TS 23.041 and is incorporated herein by reference. In addition to messaging between mobile device users, messages (e.g., ads, public messages) can be broadcast to mobile devices within a geographical region. SMS messages sent from a mobile device can be forwarded to Short Message Service Centers (SMS-C) which can store and/or forward the text message to a recipient. If the recipient mobile device cannot be reached or is not available, the SMS-C can store the message in a queue to be sent later. In some instances, the SMS-C attempts transmission once and does not store unsent messages in a queue for later retry. In some situations, a user may request delivery reports to receive a confirmation when a text message has been delivered to the receiving mobile device.

Typically, the transmission of text messages between the mobile device and the SMS-C is managed by the Mobile Application Part (MAP) of the SS7 protocol. The MAP specification is described in 3GPP TS 29.002 and the contents are incorporated herein by reference. MAP allows various communications networks (e.g., GSM, UMTS mobile core networks, GPRS core networks, etc.) to interact with one another to deliver services to mobile devices. In addition to SMS, the applications facilitated by MAP include, by way of example but not limitation, mobility services for location management and authentication, operation and maintenance, call handling, supplementary services, Packet Data Protocol (PDP) services for GPRS, and/or location service management services.

The SS7 protocol is a standard described by the ITU Telecommunication Standardization Sector (ITU-T) and includes functions such as, but is not limited to, Message Transfer Part (MTP) to provide transfer an delivery of signaling information across networks, Signaling Connection Control Point (SCCP) to provide routing capabilities via SubSystem Numbers (SSNs), ISDN User Part (ISUP) to provide transport of call set-up information between signaling points, Interconnect User Part (IUP) to support customer services and network features at point of interconnect between pubic networks, Transaction Capability Application Part (TCAP) to provide capability of transferring non-circuit-related information between signaling points, and Telephone User Part (TUP) to provide transport of call set-up information between signaling points for voice services, etc.

In addition, GSM provides Unstructured Supplementary Service Data (USSD) capabilities to mobile devices to support transmission of information over signaling channels of the GSM network. USSD is a communications technology that can be used to send data (e.g., text) between a mobile device and an application program in the network. USSD is defined in the GSM standard in GSM 02.90 (USSD Stage 1), GSM 03.90 (USSD Stage 2), and GSM 04.90; the contents are herein incorporated by reference. USSD Phase 1 in general supports mobile-initiated operations (as opposed to network-initiated operations). Therefore, the mobile device can send a USSD command to the network and receive a response. In other words, a USSD Phase 1 communication session typically comprises one request and one answer (e.g., one USSD transaction). With USSD Phase 2, a dialogue can generally be established between the mobile device and the wireless network. Multiple USSD operations can typically be sent within a communication session. In addition, the dialogue with USSD Phase 2 can be network (application)-initiated or mobile station-initiated.

In most instances, USSD can provide a text-based, bidirectional, interactive, and session-oriented channel of communication between mobile devices and servers in the Home Public Land Mobile Network (HPLMN) and the Visited Public Land Mobile Network (VPLMN) of mobile subscribers. USSD messaging service is typically session-based thus resulting in faster response times compared to messaging services that are store-and-forward services such as SMS. Thus typically, once a USSD command/message has been sent to a service provider, a response can be received within a few seconds. In some applications, a USSD command is sent to query available balance and/or call logs in pre-paid GSM services. The mobile device user can, in some instances, communicate with a wireless application provided by the wireless service provider (e.g., operator) in a manner that is transparent to the mobile device and intermediate network entities.

The instant messaging network 112, can establish connections with one or more of the client devices 106A-N through any known and/or convenient protocol, such as, but is not limited to Session Initiation Protocol (SIP), SIP for Instant Messaging and Presence Leveraging Extensions (SIMPLE), Application Exchange (APEX), real time messaging protocol (RTMP), Presence and Instant Messaging Protocol (Prim), Extensible Messaging and Presence Protocol (XMPP), instant messaging and presence protocol (IMPP), Open Mobile Appliance (OMP), Instant Messaging and Presence Service (OMP), etc.

IM service providers that provide the IM services which can be accessed by mobile devices over a wireless network, can include, but are not limited to, AIM, Jabber, EBuddy, Windows Messenger, Yahoo! Messenger, QQ, Skype, Sametime, Xfire, ICQ, Gadu-Gadu, Paltalk, MXit, PSYC, Meebo, etc. The IM server 114 (e.g., a Jabber/XMPP server) can provide and manage one or more of the above mentioned protocols (e.g., SIP, OMP, XMPP) to provide access to the instant messaging network 112 by allowing various IM software clients (e.g., Gabber, Exodus, Google Talk, etc.) to utilize the protocols to provide connectivity to end users (e.g., client devices 106A-106N).

IM protocols can operate with one or more types of networks. For example, the network through which IM servers provide services to a client device may be a telephonic network, an open network, such as the Internet, or a private network, such as an intranet and/or the extranet. For example, the Internet can provide file transfer, remote log in, email, news, RSS, and other services through any known and/or convenient protocol, such as, but is not limited to the TCP/IP protocol, Open System Interconnections (OSI), FTP, UPnP, iSCSI, NSF, ISDN, PDH, RS-232, SDH, SONET, etc.

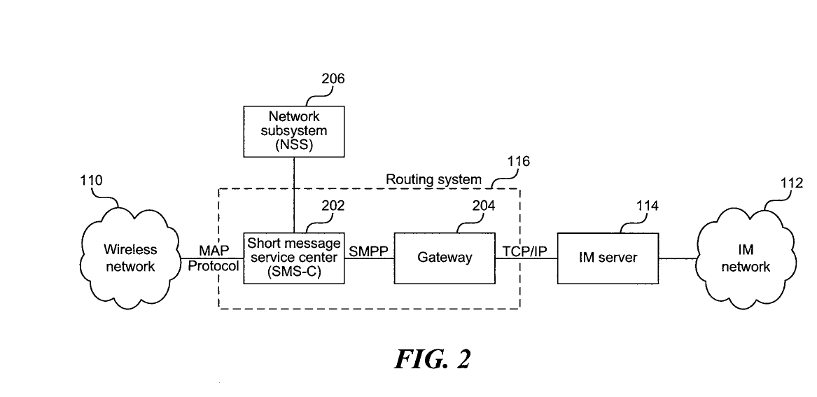

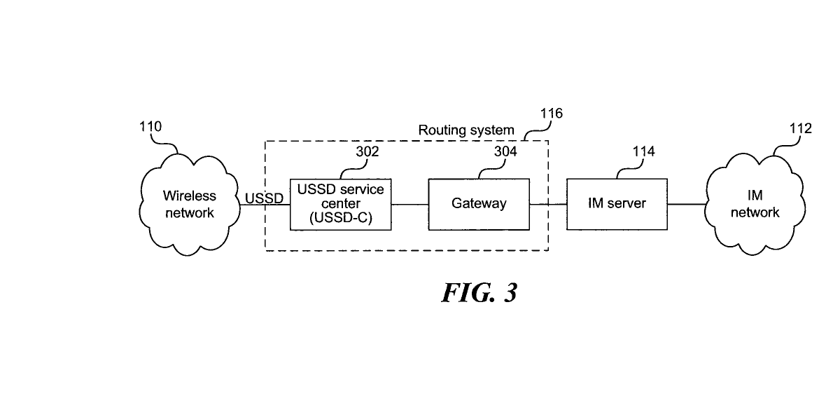

The routing system 116 can include one or more of a USSD service center (USSD-C) and an SMS service center (SMS-C). They routing system 116 may further include a gateway, as shown in FIGS. 2-3 for interfacing the wireless network 110 to another network (e.g., instant messaging network 112) that utilizes one or more different protocols. The routing system 116 can include one or more components having any combination of software agents and hardware modules for facilitating a mobile device operator (e.g., a user of mobile devices 102A-102N) to communicate with a client device user (e.g., a user of client devices 108A-N) through a wireless network (e.g., the wireless network 110) and an instant messaging network (e.g., the IM network 112).

RFC 821 published by the Internet Engineering Task Force (IETF) describes the Simple Mail Transport Protocol (SMTP) the contents of which are herein incorporated by reference. RFC 1459 published by IETF describes the Internet Relay Chat (IRC) protocol, a system for text-based conferencing in TCP/IP networks, the contents of which are herein incorporated by reference. RFC 3920, 3921, 3922 and 3923 published by IETF describe the Extensible Messaging and Presence Protocol (XMPP), a protocol for “instant messaging” (IM) applications in TCP/IP networks, the contents of which are herein incorporated by reference.

FIG. 2 depicts a block diagram illustrating a plurality of network elements in a routing system 116 to couple a wireless network 110 to an IM network 112, according to one embodiment.

In accordance with embodiments of the present disclosure, the plurality of network elements can include a Short Message Service Center (SMS-C) 202 and a gateway 208. The SMS-C 202 can be any network element able to manage, store, receive and/or deliver SMS messages. For example, when a text message is sent from a mobile device, the SMS-C is able to store the text message until the text message can be sent to the receiving device. In some instances, the SMS-C can be configured to store the text message for a predetermined amount of time. In addition, the mobile device operator can specify how much time the message is to be stored before it is attempted to be sent to the recipient. In addition, messages can be sent by applications and/or mobile service providers (e.g., operators). For example, a voice mail server may send a text message to a mobile device indicating new voice mail messages. In addition, service providers can send confirmations and/or notifications in bulk to mobile device users of interest. In one embodiment, the SMS-C is able to identify the recipient based on a destination address in a mobile device-initiated message.

The gateway 204 can include a number of components such as, but is not limited to, protocol transistors, impedance matching devices, rate converters, fault isolators, signal translators, etc., to interface to one or more networks with different protocols than the protocols under which the original signal was sent. The gateway 204 can further facilitate the establishment of a set of rules and administrative procedures between different network protocols such that communication can be established. Typically, protocol converters such as gateways can operate at any network layer (e.g., the application layer, the presentation layer, the session layer, the transport layer, the network layer, the data link layer, and/or the physical layer) of the Open System Interconnection (OSI) model and convert one protocol stack into another. For example, a gateway can connect a LAN to the Internet. Similarly, gateways can also connect two IP-based networks.

In accordance with one embodiment of the present disclosure, the SMS-C includes hardware modules and/or software agents to identify a destination address in a mobile device-initiated SMS message indicating that the SMS message is relevant to one or more IM services. The SMS-C may be connected to a Network Switching Subsystem (NSS) which facilitates communications between mobile devices and the Public Switched Telephone Network (PSTN). In one embodiment, the SMS-C additionally compares the identified destination address of the SMS message with a list of predetermined addresses to determine whether the messages is to be sent to an IM server.

In one embodiment, the identified SMS messages to be sent to an IM service are forwarded to a gateway (e.g., gateway 204) by the SMS-C 202. The gateway 204, for example, can be coupled to the SMS-C through the Short Message Peer-to-Peer Protocol (SMPP). Versions of SMPP (e.g., v.3.3, v.3.4, v.3.5) currently available and versions to be available in the future can be utilized in accordance with embodiments of this disclosure.

The gateway may be any combination of hardware modules and software agents able to convert an SMS message to the TCP/IP standard. In one embodiment, connection between the SMS-C and the Internet and/or other TCP/IP-based networks can be established via the SMPP protocol provided by the gateway. The gateway may further be connected to the IM server 114 through a TCP/IP network. In one embodiment, the gateway is connected to the IM server 114 via the XMPP protocol, which is typically compatible with real-time or near-real-time communications and managing presence information of subscribers.

In other embodiments, connections to the IM server 114 can be established using multiple protocols, including but is not limited to, Session Initiation Protocol (SIP), SIP for Instant Messaging and Presence Leveraging Extensions (SIMPLE), Application Exchange (APEX), real time messaging protocol (RTMP), Presence and Instant Messaging Protocol (Prim), Extensible Messaging and Presence Protocol (XMPP), instant messaging and presence protocol (IMPP), Open Mobile Appliance (OMP), Instant Messaging and Presence Service (OMP), etc. to provide access to one or more IM service providers via one or more IM networks (e.g., IM network 112). In some embodiments, the routing system 116 further includes components to facilitate communications between USSD-based services and an IM network, as shown in the example of FIG. 3.

FIG. 3 depicts a block diagram illustrating a plurality of network elements in a routing system 116 to couple a wireless network 110 to an IM network 112, according to one embodiment.

The routing system 116 can include network elements such as the USSD service center (USSD-C) 302 and a gateway 304. USSD messages can be relayed by the USSD-C 302 which can be implemented with any combination of software agents and/or hardware modules. In one embodiment, the USSD-C 302 identifies the service code of a USSD message/command to determine if the USSD session (e.g., a user-initiated USSD session) includes a request to access an IM service, in accordance with embodiments of the present disclosure. The identified service code (e.g., “#100#”) can be compared with a list of predetermined service codes to determine if the USSD message and/or command are relevant to an IM server and/or an IM protocol.

In one embodiment, the USSD-C forwards the USSD commands/messages of a USSD session relevant to an IM service to the gateway. Alternatively, the USSD-C may utilize contextual information about the USSD session to determine that the user has selected to access the IM service among one or more services offered in an USSD menu. Similarly, the gateway 304 may be any gateway able to convert an USSD-based message/command to be compatible with the TCP/IP standard. In one embodiment, connections between the SMS-C and the Internet and/or other TCP/IP networks can be established via the SMPP protocol provided by the gateway. The gateway may further be connected to the IM server 114 through a TCP/IP network. In one embodiment, the gateway is connected to the IM server 114 via the XMPP protocol.

For example, when the gateway 304 receives a USSD session request to access the IM network 112, the gateway can send a USSD message offering a menu of services provided by the IM service to be presented via a graphical interface on the mobile device. The example services include, configuring login information, passwords, and/or other forms of identity verification information. The menu can further include options for the mobile device user to update presence and/or visibility information, configure online privacy settings, display the presence information of other users, invite other users, initiate chat sessions, and/or send text messages to one or more users. Additional IM services are contemplated in addition to those described and can similarly be provided in a USSD menu sent by the gateway; the applications of which not specifically described are also in accordance with the spirit of the present disclosure.

In one embodiment, the gateway 304 can receive requests for such actions initiated from the mobile device in the form of USSD messages. The gateway further facilitates XMPP transactions with the IM server depending on the messaging protocol employed by the IM server. Communication can be estimated based on other protocols. In addition, the gateway 304 may be configured to provide a status and/or result of a request to access IM services by sending a USSD or SMS message to the mobile device.

In some embodiments, multiple connections to different IM servers can be established via SMS and/or USSD such that a mobile device can communicate with different IM services utilizing same/different IM protocols. Similarly, connections to an IM server with multiple communications protocols can also be established, concurrently, or independently. For example, the mobile device user may wish to send messages to friends on Google Talk and AOL Instant Messenger. The gateways 204 and/or 304 of FIGS. 2-3 can thus protocol convert the mobile device-initiated SMS and/or USSD messages to be compatible with the messaging protocols utilized by Google Talk and AIM, for example. In one embodiment, the gateway establishes an IM connection (e.g., XMPP) to an IM server (e.g., a Jabber server).

The gateway may maintain the XMPP connection for a predetermined amount of time after the user closes the USSD session to allow the user to temporarily leave the USSD-based IM session to access other functions provided by the mobile device, for example, to read or compose SMS messages and return to the USSD-based IM session.

In engaging in IM services, the IM server may route data (e.g., messages, attachments, and/or notifications) that are intended to be received by a mobile device user to the gateway, in one embodiment. For example, the IM server may route an IM-based message to the gateway to be routed to the mobile device. The IM server can send an invitation from another IM user and/or send a notification indicating that the presence status of another user has been updated (e.g., user has entered/exited idle status, user has gone offline, user has gone online, etc). Other types of messages and notifications that can be sent from the IM-based service are contemplated and the applications to handling of any such messages, attachments, and/or notifications initiated from the IM server to be delivered to one or more mobile devices are in accordance with the embodiments of this disclosure.

In situations where the IM server is to deliver a message to a mobile device, directly or in-directly. The gateway, in one embodiment, identifies an optimal way of relaying the message/notification to the mobile device. For example, if a mobile device user is currently engaged in a USSD session, or can be expected to initiate a USSD session within a predetermined amount of time, the gateway can store the IM initiated message/attachment/notification and schedule for it to be enclosed in a USSD message to be sent when the mobile device is engaged in a USSD session. In some embodiments, the IM initiated message/attachment/notification can be sent as an SMS message. For example, when the mobile device is not currently engaged in a USSD session, and does not initiate a USSD session for a predetermined amount of time.

The routing system 116 shown in FIGS. 2-3 can include one or more modules to receive SMS and/or USSD messages/commands. For example, the functions performed by the USSD-C and SMS-C can be implemented in one module, although illustrated as two separate modules. In one embodiment, the routing system 116 can include both the USSD-C and SMS-C. Similarly, the routing system 116 can include one gateway able to convert both USSD and SMS messages to a message that is compatible with the IM server 114, such as, but not limited to, the TCP/IP protocol. In other embodiments, the routing system 116 can include two separate gateways for protocol converting the USSD and SMS messages.

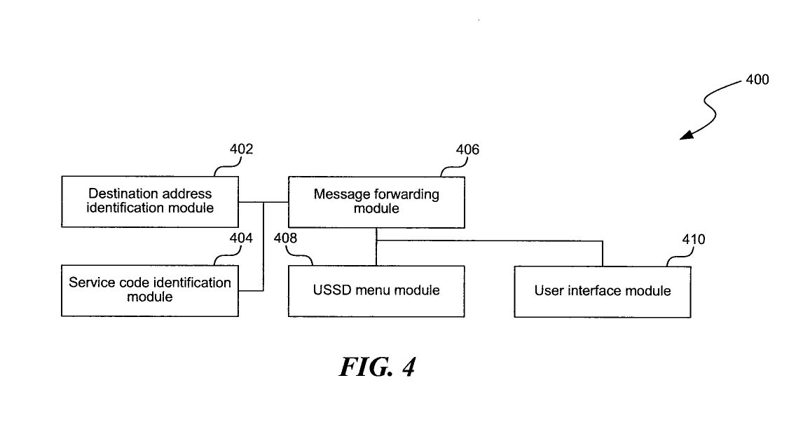

FIG. 4 depicts a block diagram illustrating components of a system 400 for coupling a wireless network to an IM network, according to one embodiment.

In the example of FIG. 4, the system 400 includes a destination address identification module 402, a service code identification module 404, a message forwarding module 406, a USSD menu module 408, and/or a user interface module 410. Additional or less modules can be included without departing from the spirit of the novel art of this disclosure. In addition, the modules illustrated in the example system of FIG. 4 can include any number and combination of sub-modules, and systems, that are implemented with any combination of hardware and/or software modules.

The destination address identification module 402 can be any combination of software agents and/or hardware modules able to identify the destination address of a mobile device-initiated SMS message from at least a portion of the SMS message, in accordance with one embodiment of the disclosure. The destination address identification module 402 can, in some embodiments, compare the identified destination address from the SMS message to a predetermined set of addresses including information about the communication protocols associated with the addresses. For example, the destination address may indicate that the message is intended to be sent via SMS to another mobile device user. In another example, the destination address may indicate that the message is to be sent to an IM server via the XMPP protocol. In one embodiment, multiple destination addresses may be identified from an SMS message. For example the destination addresses may indicate that the message is to be sent to a Jabber server via the XMPP protocol and the AIM server via the OSCAR instant messaging protocol. Further, the SMS message may have multiple address identifiers indicating that the message is to be sent via SMS and instant messaging.

In accordance with one embodiment of the present disclosure, the service code identification module 404 is any combination of software agents and/or hardware modules able to identify the service code of a USSD message/command. USSD commands may be formatted as “*123#”. Note that service commands for accessing similar services via different wireless service providers can be associated with different service codes. In one embodiment, the service code identification module 404 identifies the service code of a mobile device-initiated USSD message/command. Further, the service code identification module 404 can, in some embodiments, compare one or more identified service codes to a predetermined set of service codes including information about the communication protocols associated with the service codes.

For example, the service code may indicate that the message is intended to be sent to another mobile device user. In a further example, the service codes may indicate that the message is to be sent to an IM server via the XMPP protocol. In some embodiments, multiple service codes may be identified from the USSD message/command. For example the destination addresses may indicate that the message is to be sent to a Jabber server via the XMPP protocol and the AIM server via the OSCAR instant messaging protocol. Further, the USSD message/command may have multiple service codes indicating that the message is to be sent via USSD and instant messaging.

When a mobile device-initiated message (e.g., SMS message, USSD command, and/or USSD message) is identified to be intended to be relayed to one or more IM servers, the destination address identification module 402 and/or the service code identification module 404 can send the message to the message forwarding module 406. In accordance with one embodiment of the disclosure, the message forwarding module 406 can be any combination of software agents and/or hardware modules able to receive mobile device-initiated SMS and/or USSD messages to be forwarded to one or more specified IM servers such that a mobile device user can communicate with an IM service subscriber. For example, the message forwarding module 406 can forward the mobile device-initiated messages via SMPP to one or more IM servers. Protocols in addition to SMPP that provide access to a TCP/IP based network from a SMS-C or a USSD-C can also be utilized.

Based on the service codes identified from the USSD message/command and/or the destination address identified from the SMS message, the mobile device-initiated messages are forwarded to the intended IM server. In one embodiment, the message forwarding module 406 performs various tasks associated with converting a mobile device-initiated message to interface with an IM protocol for communicating with one or more IM users. In one embodiment, the message forwarding module 406 performs protocol versions between mobile initiated messages and various instant messaging protocols, including, but is not limited to, Session Initiation Protocol (SIP), SIP for Instant Messaging and Presence Leveraging Extensions (SIMPLE), Application Exchange (APEX), real time messaging protocol (RTMP), Presence and Instant Messaging Protocol (Prim), Extensible Messaging and Presence Protocol (XMPP), instant messaging and presence protocol (IMPP), Open Mobile Appliance (OMP), Instant Messaging and Presence Service (OMP), etc.

In accordance with embodiments of the present disclosure, the message forwarding module 406 can be any combination of software agents and/or hardware modules able to further receive messages and/or notifications initiated from an IM server to be relayed to a mobile device, as an SMS and/or USSD message. Similar to transmitting messages to an IM server, the message forwarding module 406 can perform the relevant protocol translation tasks associated with providing an IM initiated message to a mobile device (e.g., via SMS and/or USSD).

In some embodiments, the message forwarding module 406 determines, on a case by case basis, the optimal mechanism to forward an IM initiated message to a mobile device. Based on the determined optimal mechanism (e.g., SMS or USSD), the message forwarding module 406 performs the relevant protocol translations. For example, if the mobile device is currently engaged in a USSD session, the message can be forwarded as a USSD message. If the mobile device is not engaged in a USSD session, the message forwarding module may wait for a predetermined amount of time for the mobile device to enter a USSD session before sending the IM-initiated message via SMS.

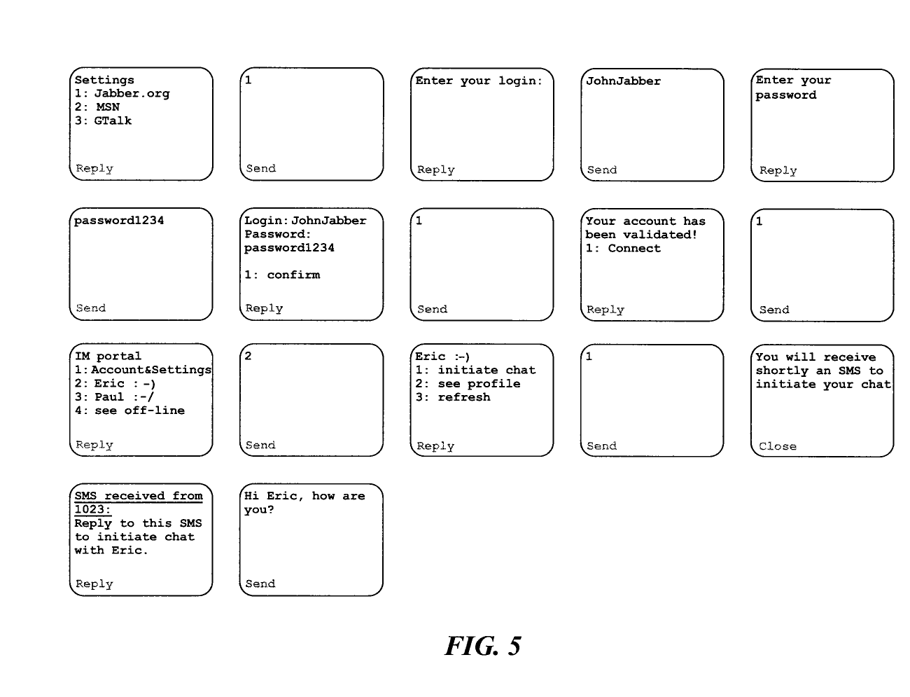

In accordance with one embodiment of the present disclosure, the USSD menu module 408 can be any combination of software agents and/or hardware modules able to provide a menu in a USSD message for accessing one or more functions provided by an IM service to a mobile device. The IM services to be offered include, but are not limited to service configuration, privacy settings, presence information, visibility settings, adding/deleting/inviting friends, organizing a buddy list, read/compose/send messages, etc. In some embodiments, the USSD menu interface is customizable by the wireless service provider. The customizable aspects of the USSD menu include but are not limited to, interface, content, etc. FIG. 5 illustrates example screenshots of user interfaces displayed on a mobile device for accessing IM services.

In accordance with embodiments of the present disclosure, the user interface module 410 can be any combination of software agents and/or hardware modules able to generate a user interface to be displayed on the mobile device. In some instances, the user interface may be customizable by the wireless service provider. In addition, the display format of the user interface may be customizable by the user for suitability with the mobile device display screen. The user interface module 410, in some instances, can handle and satisfy requests from wireless service providers and users to adjust and/or generate the user interface based on the commands and/or requests otherwise received. In some embodiments, the UI module 410 interacts with the USSD menu module 408 to determine a suitable interface to provide the USSD menu options to be displayed on a mobile device.

The system 400, although illustrated as comprised of distributed components (physically distributed and/or functionally distributed), could be implemented as a collective element. In some embodiments, some or all of the modules, and/or the functions represented by each of the modules can be combined in any convenient or known manner. Furthermore, the functions represented by the modules can be implemented individually or in any combination thereof, partially or wholly, in hardware, software, or a combination of hardware and software. In addition, the system 400 can represent any one or a portion of the functions described for the modules. More or less functions can be included, in whole or in part, without deviating from the novel art of the disclosure.

FIG. 5 illustrates example screenshots of user interfaces for a mobile device for accessing IM services and managing IM subscriptions, according to one embodiment.

Screenshot 502 illustrates a user interface displayed on a mobile device for configuring access to an IM service. In the example screenshot of FIG. 5, the user interface allows a user to specify a particular IM server (e.g., Jabber.org, MSN, and/or GTalk, etc.), a user ID (“JohnJabber”), and a password (password1234). With this particular IM service, a username/email and password identification method for authorizing access is utilized. The user can elect to save the settings by confirming the input through the interface, for example, by selecting the option ‘1’ (“1: confirm”) in the user interface.

The user interface, can additionally, in some embodiments, be provided to a user to determine if the user is authorized to access the system and if so, logs the user into the IM services system. A user may be able to specify and/or obtain a logon ID after subscribing or registering with the IM services. Once a user has been connected to an IM service, a listing of accessible services is provided in a menu listing. For example, the user can access the account and/or settings, contacts, etc. via a USSD browsing menu (“IM portal: 1: Account & Settings 2: Eric :-) 3: Paul :-/ 4: see off-line”).

In particular, a user interface can be displayed on the mobile device for managing a list of ‘buddies’. The ‘buddies’ can be friends/acquaintances of the mobile device user that are also subscribed to the same IM services (“Jabber”). A user's buddies may have accepted a friend request from the mobile device user. In most situations, the user interface can be configured to display the list of buddies in a predetermined manner. The buddies that are online are displayed in the buddy list on the screen with priority. In other embodiments, the user interface can be configured to display the list of buddies in alphabetical order, regardless of the presence status of the user. In some embodiments, the user (“JohnJabber”) can manually adjust the priority in which buddies are to be listed.

Once a user has been selected from the buddy list, various actions and interactions that can be performed can be provided in a selectable menu. The actions that can be performed include but are not limited to those shown in the example of FIG. 5, initiating a chat session, see a user profile, and/or refresh the screen. When the chat option is selected (e.g., option ‘1’, initiate chat), a user interface is displayed on the mobile device for participating in a chat session with another user. In this example, the user (“JohnJabber”) is shown to be chatting with his buddy (“Eric”). The text entry field can be utilized to compose messages prior to sending them. The ‘send’ and/or ‘reply’ buttons can be used to send the message to the recipient. In other embodiments, the user (“JohnJabber”) engages in a group chat session such as a chat room where there are multiple participants in the chat session. Similarly, the user (“JohnJabber”) can be engaged in multiple chat sessions via different IM services, for example, simultaneously.

Although the user interfaces of FIG. 5 illustrate one active chat session established via one IM service, it is to be noted that multiple chat sessions, via same or different IM service providers could be active simultaneously. Depending on the IM service provider, the wireless service provider, and/or user settings, multiple chat sessions can be displayed simultaneously on the screen, or some chat sessions can be minimized and/or hidden until a message has been received, for example. Other user interfaces to facilitate access of IM services/functions convenient and/or known are contemplated and are in accordance with the embodiments of this disclosure.

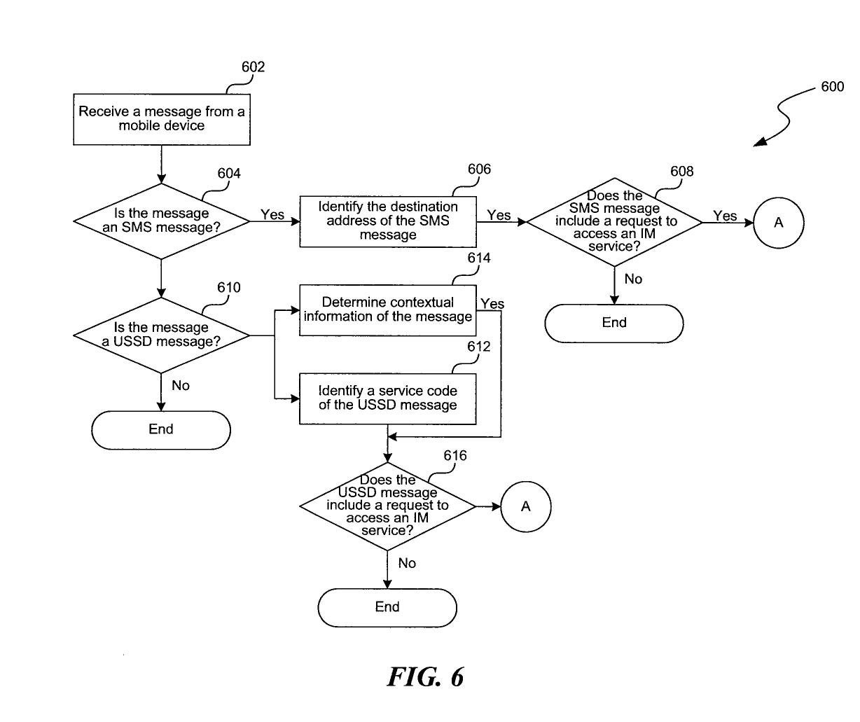

FIG. 6 depicts a flow diagram 600 illustrating a process of identifying a request to access an IM service via a mobile device, according to one embodiment.

In process 602, a mobile device-initiated message is received. In one embodiment, the message includes textual data. In process 604, if the mobile-device initiated message is determined to be an SMS message, in process 606, the destination address is identified. The destination address can be embedded in the SMS message as an SMS parameter via any known and/or convenient manner. GMS Technical Specification 03.40 published by ETSI describes SMS and is herein incorporated by reference.

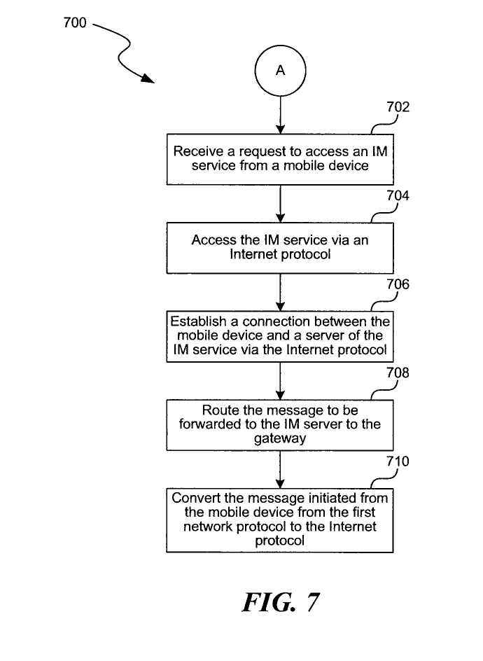

In one embodiment, the destination address can be compared to a list of predetermined addresses to determine the protocol over which the mobile-initiated message is to be sent. An error message may be sent back to the mobile device if the destination address does not match an address on the list of predetermined addresses or if the destination address is invalid. In process 608, based on the destination address, it is determined whether the mobile device-initiated message includes requests to access one or more IM services. If so, the process continues at “A” in the flow chart of FIG. 7.

In process 610, if it the mobile-initiated message is not an SMS message, it is determined whether the message is a USSD command/message. A USSD command/message typically includes a short code having a format that complies with the USSD standard. The specific codes and contents accessible via the specific codes are in most instances specific to wireless service providers. If the message is determined to be a USSD command/message, the message can then be routed to a USSD gateway, where in process 612, service code of the USSD message can be identified. For example, different service codes can be associated with different IM services, with same or different communications protocols.

The identified service code, can, in some embodiments, be compared to a predetermined list of service codes to determine where the message is to be routed, and the communications protocol over which the message is to be routed. In some instances, the USSD message can further include a request for service-related information. The message can then be routed to the USSD gateway and to the relevant application identified by the request for the service-related information. The application can then send the response back to the mobile device, sometimes, within the same USSD session.

In some embodiments, where the USSD II standard is utilized for communication, a USSD session can support multiple sequences of messages between the mobile device and the application. In addition, a USSD session can also be initiated by the application. In process 616, based on the service, it is determined whether the mobile device-initiated USSD message includes a request to access one or more IM services. If so, the process continues at “A” in the flow chart of FIG. 7. In process 614, the contextual information of the USSD message is determined, in accordance with one embodiment of the disclosure. The contextual information can be determined to identify requests to access IM services. In addition, contextual information can provide an indication as to whether the contents of the message are relevant to one or more IM services. If so, the process continues at “A” in the flow chart of FIG. 7.

FIG. 7 depicts a flow diagram 700 illustrating a process of sending a mobile device-initiated message to an IM server via a wireless network, according to one embodiment.

In process 702, a request to access one or more IM services is received from a mobile device. The request can be identified via one or more of the processes illustrated in FIG. 6. Additional processes for identifying requests for IM services in mobile-initiated messages are contemplated in addition to those explicitly discussed in association with the flow chart of FIG. 6 and are considered to be within the scope and spirit of the embodiments of this disclosure. In process 704, the IM service is accessed via an Internet protocol (e.g., TCP/IP), for example, in process 706, a connection between the mobile device and one or more IM servers are established via the Internet protocol. The connection can be established over a number of protocols depending on the communications protocol utilized by the one or more IM servers.

In process 708, the mobile device-initiated message to be forwarded to IM server is forwarded to the gateway. Depending on whether the message is a USSD or an SMS message, the mobile device-initiated message can be forwarded to a USSD gateway or an SMS gateway. In other embodiments, the functions of a USSD and SMS gateway are implemented in one gateway and are able to receive both USSD and SMS messages. In process 710, the message initiated from the mobile device is converted from the first network protocol to the Internet protocol. The first network protocol may be USSD and/or SMS. Other wireless protocols and communications standards are contemplated, such as MMS, and are in accordance with the novel embodiments of this disclosure.

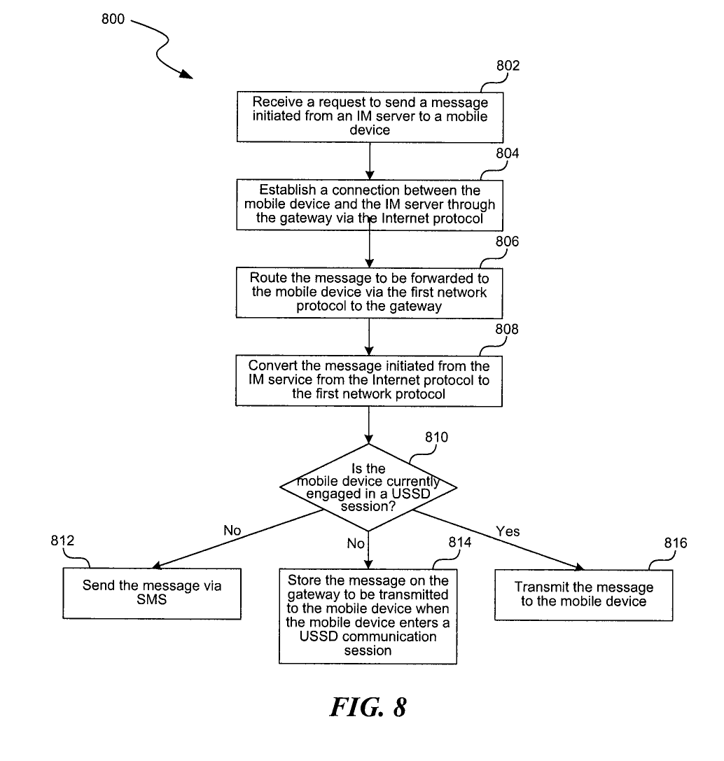

FIG. 8 depicts a flow diagram 800 illustrating a process of sending a message initiated from an IM server to a mobile device, according to one embodiment.

In process 802, a request to send a message from an IM server to a mobile device is received. In one embodiment, the message includes text-based data. The message can include data send to the mobile device user from a second user of the IM service. The IM service can be accessed by the second user via any device able to establish a connection with the IM server, portable or non-portable, such as, but is not limited to, a laptop computer, a notebook computer, a cell phone, a Blackberry, an iPhone, etc. In addition, the message can be sent from the IM service application to the mobile device. For example, service subscription related information, alerts and notification of service upgrades, newly released functions can be sent to the mobile device.

In process 804, a connection between the mobile device and the IM server through the gateway is established via the Internet protocol. In process 806, the message to be forward to the mobile device via the first network protocol to the gateway. The first network protocol can be the Short Message Peer-to-peer Protocol (SMPP) or the Unstructured Supplementary Service Data (USSD) protocol. In process 808, the message initiated from the IM service is converted from the Internet protocol to the first network protocol. For example, the IM-initiated message can be converted to the SMPP protocol or the USSD protocol depending on whether the message is to be sent to the mobile device as a USSD message or an SMS message.

In one embodiment, the gateway determines an optimal method to provide the IM-initiated message to the mobile device. For example, in process 810, it is determined if the mobile device is currently engaged in a USSD session. If the mobile device is not currently engaged in a USSD session, the message is sent via SMS to the mobile device, in process 812. Alternatively, if the mobile device is not currently engaged in a USSD session, the message can be stored on the gateway to be transmitted to the mobile device when the mobile device enters a USSD communication session. If the mobile device is currently engaged in a USSD session, in process 816, the message is transmitted to the mobile device via a USSD message and/or command.

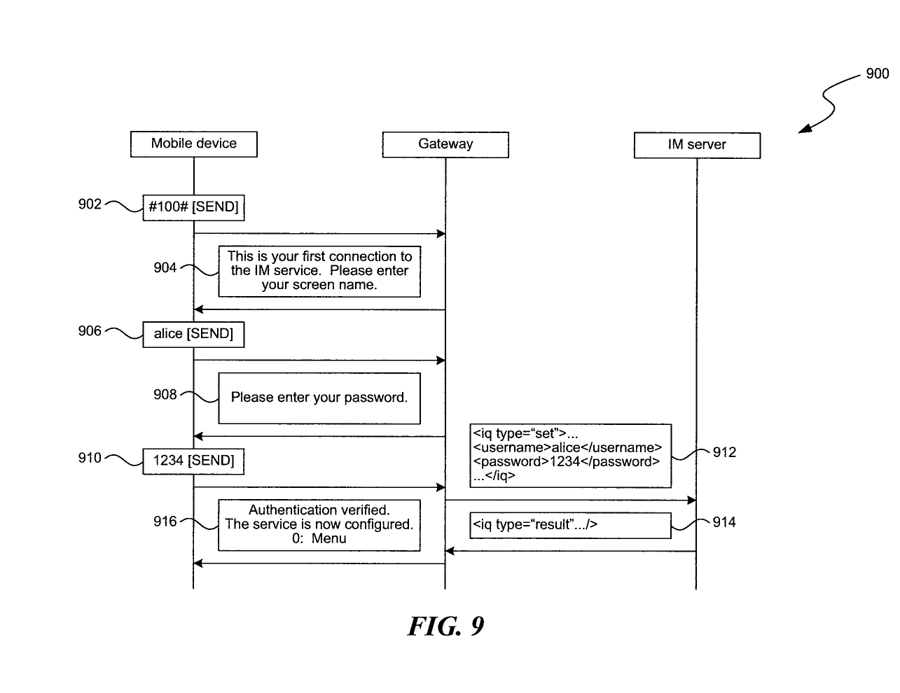

FIG. 9 depicts an interaction diagram 900 between a mobile device, gateway, and IM server for configuring the IM service via Unstructured Supplementary Service Data (USSD), according to one embodiment.

The interaction diagram illustrates the messages and commands sent among the mobile station, gateway, and IM server for a user to logon to an IM service. In one embodiment, in process 902, a mobile device user enters a predetermined USSD command (“#100#”) to request to logon to an IM network. When the request to access IM services is identified by the gateway, the gateway, in process 904, sends a USSD message back to the mobile device requesting the user to submit valid credentials (“This is your first connection to the IM service. Please enter your screen name.”). Thus, in process 906, the USSD message is received by the mobile device and a user sends a message including the requested screen name (“alice”) to the gateway.

When the gateway has received the screen name in a USSD message submitted by a mobile device user, the gateway requests that the user submit the corresponding password, in process 908 (“Please enter your password.”). In process 910, the user enters the IM password in a USSD message and sends it to the gateway.

In process 912, the gateway provides a set of data including the screen name and the password of the user wishing to logon to the IM network to the corresponding IM server. The set of data may be dependent on the protocol over which the IM server communicates over. In the example shown, the gateway sends the message (“<iq type=“set”><username>alice </username> <password> 1234</password> . . . </iq>”). The IM server can then verify the logon information by, in one embodiment, comparing the information submitted by the mobile device user with a table of registered users to determine if the logon information is valid. In process 914, the IM server provides the results of the verification process back to the gateway (“<iq type=“result” . . . />”). In process 916, the gateway can interpret the result and provide the results of the login information verification (“Authentication verified. The service is now configured. 0: Menu”) back to the mobile device.

In the example shown, the logon information submitted is valid and the user is instructed to submit the number ‘0’ to access a ‘Menu’ to the IM services available via the IM server. In some embodiments, if the logon information submitted is incorrect, the IM server can convey the failed attempt and the gateway may send a message to the mobile device requesting the user to re-enter the logon credentials. Alternatively, the gateway may present a USSD menu to the user allowing the user to reset the user name and/or password if the user has forgotten the valid logon credentials. In some embodiments, the gateway may terminate the USSD communication session after a predetermined number of failed logon attempts.

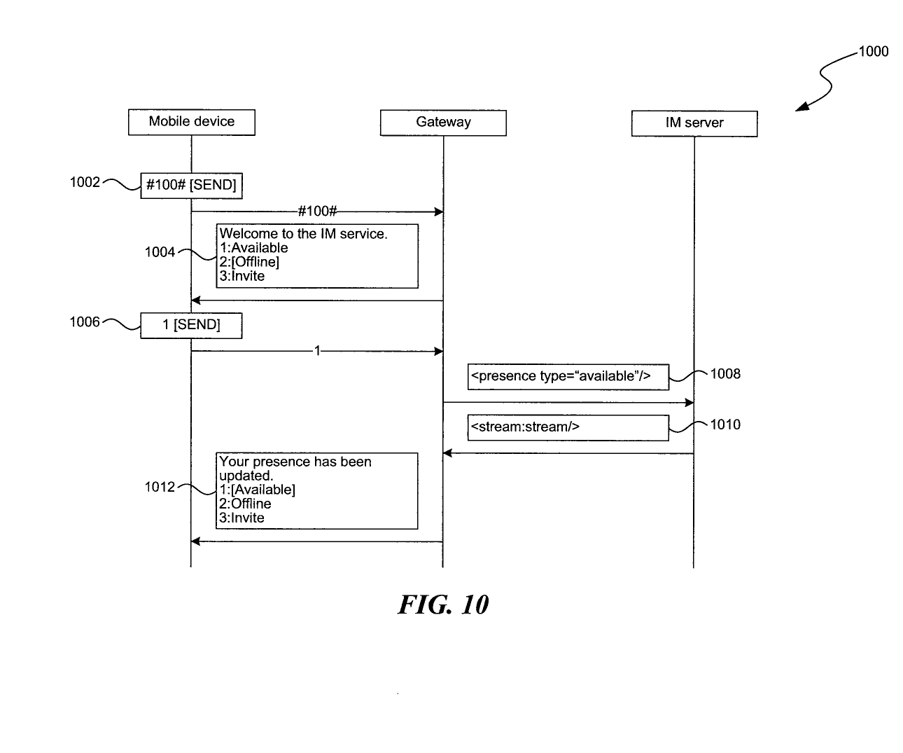

FIG. 10 depicts an interaction diagram 1000 illustrating the communications between a mobile device, gateway, and IM server for updating presence information via USSD messages/commands, according to one embodiment.

The interaction diagram illustrates the messages and commands sent among the mobile station, gateway, and IM server for a user to update his/her presence information on the IM network. The presence information is related to visibility other users and availability to be reached by other users via IM. In one embodiment, in process 1002, a mobile device user enters a predetermined USSD command (“#100#”) to request to update the user's presence information. In one embodiment, after the gateway has received the command, the gateway sends a USSD menu (“Welcome to the IM service. 1: Available, 2: [Offline], 3: Invite”) enabling the mobile device user to select a menu entry indicating the user's current presence status.

In other embodiments, additional menu options may be provided. For example, the user can elect to be appear visible to a set of friends and invisible (e.g., appear offline) to other users. In addition, the user can select to be in an ‘idle’ state, when the user has not engaged in IM messaging for a predetermined amount of time. Other presence statuses are contemplated and can be presented in a USSD menu to a mobile device user in a similar manner and do not depart from the spirit of this disclosure. In process 1006, the user selects the entry (“1”) indicating availability to be reached. When the gateway receives the user's menu selection, the gateway, in process 1008 sends a message via the communications protocol employed by the IM server indicating that the user wishes to update his/her presence status.

The message sent by the gateway to the IM server may be formatted differently depending on the IM server and/or the communications protocol employed by the IM server. In process 1008, the gateway sends the message (“<presence type=“available”/>) to the IM server. In process 1010, the IM server sends a message/command to the gateway (“<stream:stream/>) indicating the status of the request. After the gateway receives the status update of the request to change presence status, the gateway, in process 1012, sends another USSD menu to the user indicating that the presence status has been successfully updated on the IM server and the menu allows the user to update the presence status. (“Your presence has been updated. 1: [Available], 2: Offline, 3: Invite”). In situations where the status update is unsuccessful, the user may be asked to try again later. For example, the server may be busy and/or otherwise unavailable.

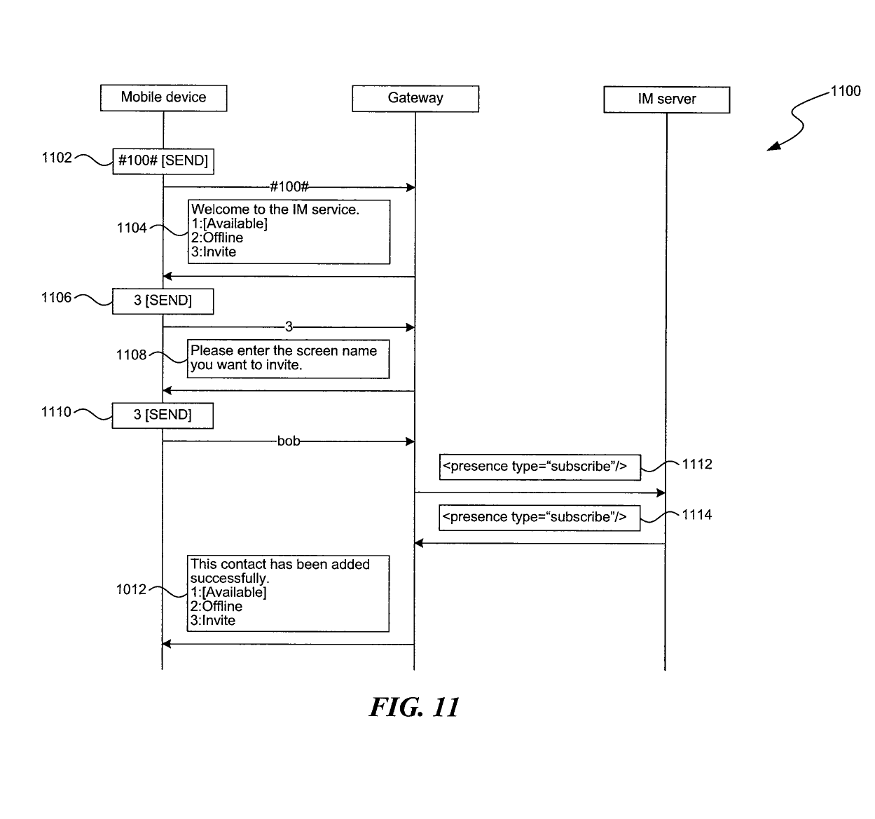

FIG. 11 depicts an interaction diagram 1100 illustrating the communications between a mobile device, gateway, and IM server for generating invitations via USSD messages/commands, according to one embodiment.

The interaction diagram illustrates the messages and commands sent among the mobile station, gateway, and IM server for a user to add another user to the ‘buddy list’. The buddy list, in some embodiments, can be a list of the user's contacts whose presence statuses are visible to the user. The user can also readily send IM messages to contacts that are on the buddy list. Additional functions may be related to building and maintaining buddy lists for IM services and the functions related to which can be provided in a USSD menu in similar or otherwise contemplated methods and do not deviate from spirit of the novel art of this disclosure.

In one embodiment, in process 1002, a mobile device user enters a predetermined USSD command (“#100#”) to request to add another user to a buddy list. Thus, after the gateway has received the command, the gateway sends a USSD menu (“Welcome to the IM service. 1: Available, 2: [Offline], 3: Invite”) enabling the mobile device user to invite other users. In process 1006, the user selects the entry (“3”) indicating that the mobile device user wishes to invite another user or add another user to the buddy list. When the gateway receives the user's menu selection, the gateway, in process 1108 sends a USSD message back to the mobile device requesting that the user submit the screen name of the friend to be invited (“Please enter the screen name you want to invite”). In process 1110, the user submits the screen name (“bob”) of the friend the user wishes to add to the buddy list.

When the gateway has received the screen name, in process 1112, a message is sent to the IM server indicating a request to add another user to the buddy list (“<presence type=“subscribe”>”). The result of the request (“<presence type=“subscribed”>”) is then sent back to the gateway from the IM server, in process 1114. The gateway sends a message back to the mobile device (“This contact has been added successfully.”) indicating the results of the request to add a user. In some embodiments, the IM server requests the permission of user to be added (“bob”) to someone else's buddy list. If the request is denied by another user, the IM server may send a message to the mobile device indicating that the add process was unsuccessful. In situations where the add process is unsuccessful, the user may be asked to try again later. For example, the server may be busy and/or otherwise unavailable. In other embodiments, the user may request to add a friend who is not currently subscribed to the IM network. Thus, the gateway and/or IM server may request that the user submit an email address such that an invitation to join the IM network can be sent.

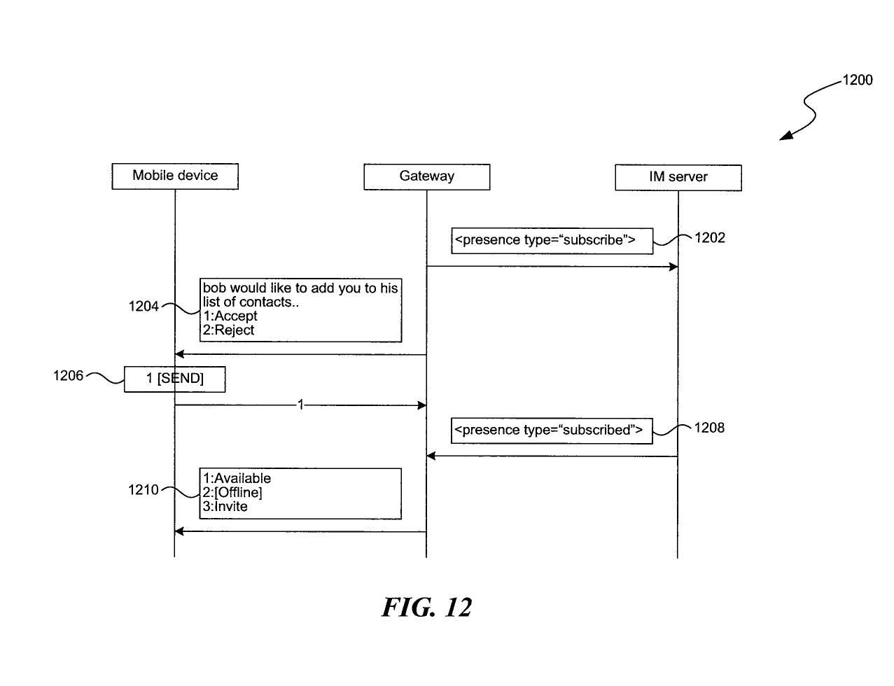

FIG. 12 depicts an interaction diagram 1200 illustrating the communications between a mobile device, gateway, and IM server for receiving invitations via USSD messages/commands, according to one embodiment.

The interaction diagram illustrates the messages and commands sent among the mobile station, gateway, and IM server for to receive an invitation request. When the IM server has received a request from another user (“bob”) to add the mobile device user to a buddy list, the IM server relays the request (“<presence type=“subscribe”>”) to a gateway, in process 1202. The gateway then sends a USSD menu (“bob would like to add you to his list of contacts. 1: Accept, 2: Reject”) to the mobile device to request permission of the mobile device user to be added to another user's (“bob”) buddy list, in process 1204.

In process 1206, the user selects the menu option ‘1’ indicating permission for ‘bob’ to add the mobile device user to the buddy list. When the gateway receives the user's menu choice, in process 1208, the gateway sends a message to the IM server (“<presence type=“subscribed”>”) to indicate permission for ‘bob’ to add the mobile device user to the buddy list (e.g., list of contacts). In process 1210, the gateway can send a USSD menu to the mobile device user offering options to change online status and/or invite other users (“Welcome to the IM service. 1: Available, 2: [Offline], 3: Invite”).

Although embodiments have been described with reference to specific example embodiments, it will be evident that the various modification and changes can be made to these embodiments. Accordingly, the specification and drawings are to be regarded in an illustrative sense rather than in a restrictive sense. The foregoing specification provides a description with reference to specific exemplary embodiments. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A method, comprising:
receiving a request to access an instant messaging service from a mobile device through a first network protocol, the instant messaging service to be accessed via an Internet protocol;
establishing a connection between the mobile device and a server of the instant messaging service via the Internet protocol through a gateway; and
routing the message to the gateway to be forwarded to the server of the instant messaging service via the Internet protocol, the gateway to convert the message initiated from the mobile device from the first network protocol to the Internet protocol.

2. The method of claim 1, wherein the message is one or more of an SMS message and a USSD message.

3. The method of claim 2, further comprising identifying the request to access the instant messaging service from the mobile device based on a destination address identifier of the SMS message initiated from the mobile device.

4. The method of claim 2, further comprising identifying the request to access the instant messaging service from the mobile device based on a service code of the USSD message initiated from the mobile device.

5. The method of claim 1, further comprising identifying the request to access the instant message from the mobile device based on contextual data of the message initiated from the mobile device.

6. The method of claim 1, wherein the first network protocol is one or more of Short Message Peer-to-peer Protocol (SMPP) and Unstructured Supplementary Service Data (USSD) protocol.

7. The method of claim 1, wherein the Internet protocol is TCP/IP.

8. The method of claim 1, wherein the Internet protocol is the Extensible Messaging and Presence Protocol (XMPP).

9. The method of claim 1, wherein the gateway is one or more of an Unstructured Supplementary Service Data (USSD) gateway, a Short Message Service (SMS) gateway, and an Instant messaging (IM) gateway.

10. The method of claim 6, wherein the message includes one or more of, availability of a user of the mobile device, login information, an invitation, and a text message.

11. The method of claim 9, further comprising presenting a user interface on the mobile device for accessing one or more functions available to the instant messaging service.

12. The method of claim 11, wherein the user interface includes a menu to access the one or more functions, the one or more functions to include, configuration of logon information, update of presence information, display of presence information of other users of the instant messaging service, invitation of the other users, and to send a message to the other users.

13. The method of claim 1, further comprising, establishing a second connection between the mobile device and a server of a second instant messaging service.

14. The method of claim 13, further comprising, establishing a third connection between the mobile device and a server of a third instant messaging service.

15. The method of claim 14, further comprising, simultaneously maintaining a plurality of connections between the mobile device and servers of a plurality of instant messaging services.

16. The method of claim 1, further comprising:
receiving a request to send a message initiated from a server of the instant messaging service to the mobile device;
establishing a connection between the mobile device and a server of the instant messaging service through the gateway via the Internet protocol; and
routing the message to the gateway to be forwarded to the mobile device via the first protocol, the gateway to convert the message initiated from the instant messaging service from the Internet protocol to the first network protocol.

17. The method of claim 16, wherein the message initiated from the server of the instant messaging service comprises one or more of a text message, a notification, an invitation, and a presence status update.

18. The method of claim 17, further comprising storing the message on the gateway to be transmitted to the mobile device when the mobile device is engaged in a USSD communication session, via the USSD protocol.

19. The method of claim 16, further comprising, determining that the mobile device is engaged in a USSD communication session and transmitting the message to the mobile device via the USSD protocol.

20. The method of claim 16, further comprising transmitting the message to the mobile device via the Short Message Peer-to-peer Protocol (SMPP).

21. A machine-readable medium embodying instructions, the instructions, which when executed, causing a machine to perform a method comprising:
receiving a request to access an instant messaging service from a mobile device through a first network protocol, the instant messaging service to be accessed via an Internet protocol;
establishing a connection between the mobile device and a server of the instant messaging service through a gateway via the Internet protocol; and
routing the message to the gateway to be forwarded to the server of the instant messaging service via the Internet protocol, the gateway to convert the message initiated from the mobile device from the first network protocol to the Internet protocol.

22. The method of claim 21, further comprising:
receiving a request to send a message initiated from a server of the instant messaging service to the mobile device;
establishing a connection between the mobile device and a server of the instant messaging service through the gateway via the Internet protocol; and
routing the message to the gateway to be forwarded to the mobile device via the first protocol, the gateway to convert the message initiated from the instant messaging service from the Internet protocol to the first network protocol.

23. A system, comprising:
means for, receiving a request to access an instant messaging service from a mobile device through a first network protocol, the instant messaging service to be accessed via an Internet protocol;
means for, establishing a connection between the mobile device and a server of the instant messaging service through a gateway via the Internet protocol; and
means for, routing the message to the gateway to be forwarded to the server of the instant messaging service via the Internet protocol, the gateway to convert the message initiated from the mobile device from the first network protocol to the Internet protocol.
